(19) United States
(12) Patent Application Publication
(10) Pub. No.: US 2025/0268154 A1
(43) Pub. Date: Aug. 28, 2025

(54) TREE SKIRT

(71) Applicant: Centresky Crafts (Shantou) Co., Ltd, Shantou (CN)

(72) Inventor: Youguo WANG, Shantou (CN)

(73) Assignee: Centresky Crafts (Shantou) Co., Ltd, Shantou (CN)

(21) Appl. No.: 18/609,803

(22) Filed: Mar. 19, 2024

(30) Foreign Application Priority Data
Feb. 23, 2024 (CN) 202420338602.7

(51) Int. Cl. A01G 13/02; A47G 33/08

(52) U.S. Cl. CPC A01G 13/27; A47G 33/08

(57) ABSTRACT

A tree skirt includes: a tree skirt body and at least two sets of support assemblies. The tree skirt body includes a plurality of flexible skirt pieces, the flexible skirt pieces are sequentially arranged along a circular track, adjacent flexible skirt pieces are detachably connected, the flexible skirt pieces are enclosed to form a cavity, and the tree skirt body has an upper opening and a lower opening communicating with the cavity. The sets of support assemblies are sequentially spaced apart along a center line of the cavity, one of the support assemblies is close to the upper opening, the other of the support assemblies is close to the lower opening, the support assemblies include at least two support strips and at least two connecting members, and each of the support strips is respectively connected to a corresponding flexible skirt piece.

### CROSS-REFERENCE TO RELATED APPLICATIONS

This application claims priority to Chinese Patent Application No. 202420338602.7, filed on Feb. 23, 2024, the content of which is incorporated herein by reference in its entirety.

### TECHNICAL FIELD

The present application pertains to the technical field of ornaments, and specifically pertains to a tree skirt.

### BACKGROUND

Tree skirts are capable of decorating and protecting plants (e.g., plants such as Christmas trees that foil the festival ambience theme, daily household green plants, etc.). A tree skirt generally includes skirt pieces and a support assembly, the skirt pieces are enclosed to form a closed ring shape, and the skirt pieces extend around the plant. The support assembly is typically a rigid circular ring arranged on an inside surface of the skirt piece to support the skirt piece, so that the skirt piece is maintained in a straight state. However, when it is not necessary to use the tree skirt, and the tree skirt needs to be stowed, it is impossible to change the shape of the support assembly and reduce a size thereof as it is an integral rigid circular ring, and the tree skirt can only be stowed and stored as a whole, which results in inconvenient stowage and storage of the tree skirt and large footprint.

In view of the problems, the present application is proposed.

### SUMMARY

The present application provides a tree skirt.

The present application provides the following technical solutions.

A tree skirt includes:
a tree skirt body, where the tree skirt body includes a plurality of flexible skirt pieces, the flexible skirt pieces are sequentially arranged along a circular track, adjacent flexible skirt pieces are detachably connected, the flexible skirt pieces are enclosed to form a cavity, and the tree skirt body has an upper opening and a lower opening communicating with the cavity; and
at least two sets of support assemblies, where the sets of support assemblies are sequentially spaced apart along a center line of the cavity, one of the support assemblies is close to the upper opening, the other of the support assemblies is close to the lower opening, the support assemblies includes at least two support strips and at least two connecting members, each of the support strips is respectively connected to a corresponding flexible skirt piece, and each of the connecting members is respectively located between adjacent two support strips and is respectively connected to the two support strips;
where the connecting member is detachably connected to at least one of the support strips.

Optionally, the connecting members extend along an arc, the connecting members are fitted to an inner surface of the tree skirt body, and one of adjacent two support strips is fixedly connected to the connecting member, and the other is detachably connected to the connecting member.

Optionally, the connecting members are respectively provided with a slot, one of the adjacent two support strips is fixedly connected to the connecting member, and the other is detachably connected to the slot.

Optionally, one of the adjacent two support strips is fixedly connected to the connecting member by any of welding, adhering, insertion and snap-in.

Optionally, the connecting member is an arc-shaped hollow tube, and the connecting member has a through slot therein; and
one of the adjacent two support strips is inserted into and in an interference fit with the slot, and the other is detachably connected to the slot.

Optionally, an outer surface of one of the adjacent two support strips at an end thereof is provided with a concavo-convex pattern portion, so that the concavo-convex pattern portion is in a close fit with an inner wall of the slot in a state of being inserted into the slot.

Optionally, the slot of the connecting member has a first slot segment and a second slot segment;
a length of the first slot segment is shorter than that of the second slot segment; and
one of the adjacent two support strips is in an interference fit with the first slot segment, and the other is detachably connected to the second slot segment.

Optionally, a connecting piece is connected to an inner surface of the flexible skirt piece, and a threading cavity is formed between the connecting piece and the flexible skirt piece; and the support strip is arranged through the threading cavity.

Optionally, both ends of the flexible skirt piece are respectively provided with a width edge;
a first adhering member is provided on one of the width edges, an extension piece is provided on the other of the width edges, and a second adhering member is provided on the extension piece; and
thickness end faces of the adjacent two flexible skirt piece are fitted together, and the second adhering member on the extension piece is adhered to the first adhering member.

Optionally, a plurality of extension pieces are provided on the width edge of the flexible skirt piece, and the extension pieces are sequentially spaced apart in an extension direction of the width edge; and
each of the support assemblies is located between adjacent two extension pieces.

### BRIEF DESCRIPTION OF THE DRAWINGS

The accompanying drawings, which are incorporated in and constitute a part of the present application, are included to provide a further understanding of the present application. Illustrative embodiments of the present application and the description thereof are included to illustrate the present application, but are not to be construed as unduly limiting the present application. Apparently, the accompanying drawings in the following description are merely some rather than all embodiments of the present application, and a person of ordinary skill in the art may still derive other drawings from these accompanying drawings without creative efforts.

FIG. 1 is a top view of a first tree skirt according to an embodiment of the present application.

FIG. 2 illustrates a view of FIG. 1 observed from another perspective.

FIG. 3 is an inside view of a second tree skirt according to an embodiment of the present application.

FIG. 4 is an exploded view of a fitting structure of connecting members, connecting pieces and support strips in a tree skirt according to an embodiment of the present application.

FIG. 5 is a bottom view of a third tree skirt according to an embodiment of the present application.

### DETAILED DESCRIPTION OF THE EMBODIMENTS

In order to make the purpose, technical solutions and advantages of the embodiments of the present application more clear, the technical solutions in the embodiments of the present application will be clearly and completely described below in conjunction with the accompanying drawings in the embodiments of the present application. The embodiments described below are for illustrative purposes only and are not intended to limit the scope of the present application.

In the description of the present application, it should be noted that the terms “upper”, “lower”, “inner”, “outer” and the like indicate orientations or positional relationships based on the orientations or positional relationships shown in the drawings, and are only for convenience of description and simplification of description, but do not indicate or imply that the device or element to be referred must have a specific orientation, be constructed and be operated in a specific orientation, and thus, should not be construed as limiting the present application.

In the description of the present application, it should be noted that, unless expressly and specifically defined otherwise, the terms “mounted” and “connected” are to be interpreted broadly, and may, for example, be fixedly or detachably or integrally connected; may be mechanically connected or electrically connected; or may be directly connected or indirectly connected through an intermediary. The specific meaning of the above terms in the present application can be understood by those of ordinary skill in the art from the specific context.

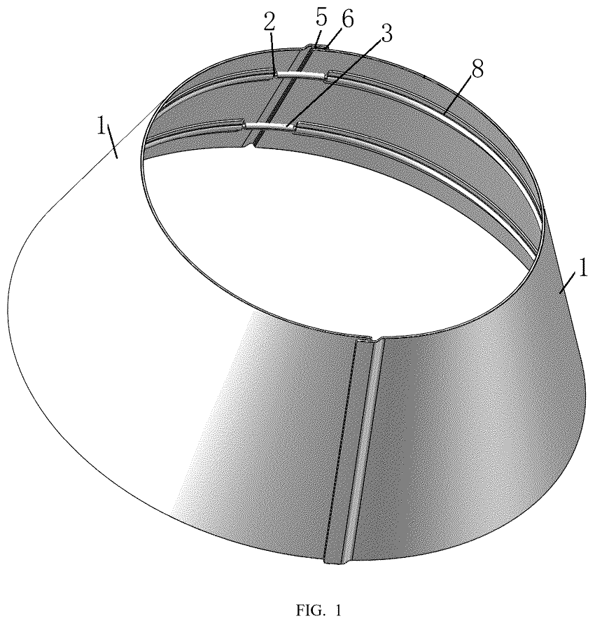

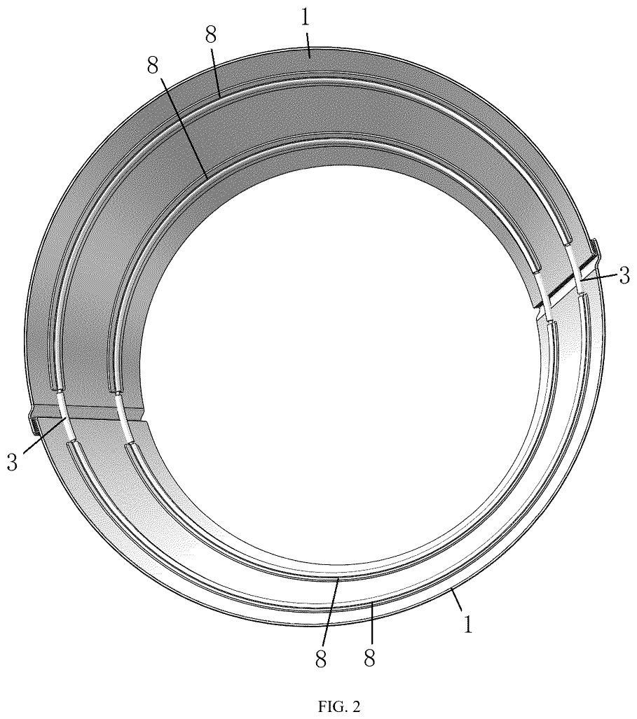

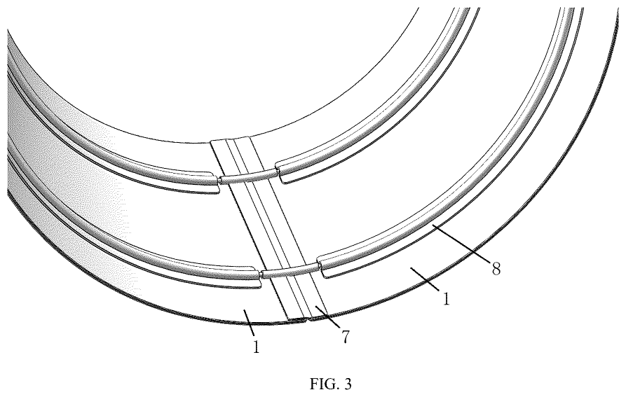

Referring to FIGS. 1-5, an embodiment of the present application provides a tree skirt, including: a tree skirt body and at least two sets of support assemblies. The tree skirt body includes a plurality of flexible skirt pieces 1, the flexible skirt pieces 1 are sequentially arranged along a circular track, adjacent flexible skirt pieces 1 are detachably connected, the flexible skirt pieces 1 are enclosed to form a cavity, and the tree skirt body has an upper opening and a lower opening communicating with the cavity. The sets of support assemblies are sequentially spaced apart along a center line of the cavity, one of the support assemblies is close to the upper opening, the other of the support assemblies is close to the lower opening, the support assemblies include at least two support strips 2 and at least two connecting members 3, each of the support strips 2 is respectively connected to a corresponding flexible skirt piece 1, and each of the connecting members 3 is respectively located between adjacent two support strips 2 and is respectively connected to the two support strips 2. The connecting member 3 is detachably connected to at least one of the support strips 2.

In the present application, the adjacent two support strips 2 are detachably separated to facilitate stowage of the tree skirt; and when the tree skirt is not used, the support strips 2 may be disassembled so that the support strips 2 are detached, thus reducing a space occupied by the support strips 2 and facilitating the stowage of the tree skirt.

In some possible embodiments, the connecting members 3 extend along an arc, the connecting members 3 are fitted to an inner surface of the tree skirt body, and one of the adjacent two support strips 2 is fixedly connected to the connecting member 3, and the other is detachably connected to the connecting member 3.

The connecting member 3 is arc-shaped to match a shape of the circular ring-shaped support assemblies. Therefore, the tree skirt deployed by the support assemblies has a regular shape, a flat surface, and is free of any severe convex or concave structure.

In some possible embodiments, the connecting members 3 are respectively provided with a slot, one of the adjacent two support strips 2 is fixedly connected to the connecting member 3, and the other is detachably connected to the slot. The support strip 2 may be made of a metal material or a high molecular material. The connecting member 3 is fixedly connected to one of the support strips 2, thus reducing the need for disassembly and assembly and avoiding loss of the connecting member 3.

In some possible embodiments, one of the adjacent two support strips 2 is fixedly connected to the connecting member 3 by any of welding, adhering, insertion and snap-in. The connecting member 3 may be a metal member or a plastic member.

The connecting member 3 is an arc-shaped hollow tube, and the connecting member 3 has a through slot therein; one of the adjacent two support strips 2 is inserted into and in an interference fit with the slot; the support strip 2 is in a close fit with an inner wall of the slot after being inserted into the slot, and will not easily move away from the connecting member 3; and the other of the adjacent two support strip 2 is detachably connected to the slot, that is, the support strip 2 may be easily inserted into the slot, and may also be removed by an external force, and relative movement between the support strip 2 and the connecting member 3 is limited mainly by a friction force between the support strip 2 and the inner wall of the slot.

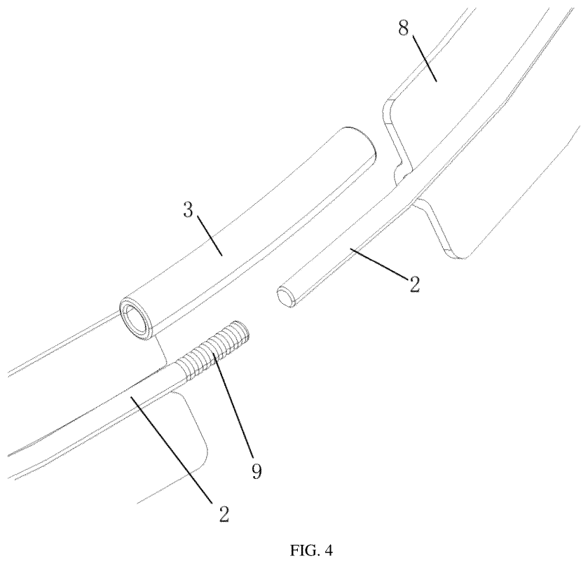

In some possible embodiments, as shown in FIG. 4, an outer surface of one of the adjacent two support strips 2 at an end thereof is provided with a concavo-convex pattern portion 9, so that the concavo-convex pattern portion 9 is in a close fit with the inner wall of the slot in a state of being inserted into the slot. The concavo-convex pattern portion 9 is in a close fit with the inner wall of the slot. Arrangement of the concavo-convex pattern portion 9 increases the frictional force between the support strip 2 and the inner wall of the slot, and improves fixing stability of the support strip 2 and the connecting member 3.

In some possible embodiments, the slot of the connecting member 3 has a first slot segment and a second slot segment; a length of the first slot segment is shorter than that of the second slot segment; and one of the adjacent two support strips 2 is in an interference fit with the first slot segment, and the other is detachably connected to the second slot segment.

One of the two slot segments is long and the other is short, and the support strip 2 inserted into the first slot segment is fixedly connected to the connecting member 3, and the other support strip 2 is detachably inserted into the second slot segment (as shown in the support strip 2 on the right side of FIG. 4). The second slot segment is long and into which the corresponding support strip 2 is detachably inserted into, which is beneficial to improve stability of an insertion structure between the connecting member 3 and the detachable support strip 2; and after the support strip 2 is inserted into the second slot segment, even if the tree skirt is slightly deformed, the support strip will not be easily withdrawn from the second slot segment, resulting in good shape stability of the tree skirt and high product reliability.

In some possible embodiments, a connecting piece 8 is connected to an inner surface of the flexible skirt piece 1, a threading cavity is formed between the connecting piece 8 and the flexible skirt piece 1, and the support strip 2 is arranged through the threading cavity.

The connecting piece 8 may be adhered to the flexible skirt piece 1 by a hook and loop fastener, the connecting piece 8 may also be sewn to the skirt piece by means of sutures, and the connecting piece 8 may also be glued to the skirt piece by means of glue. Both sides of the connecting piece 8 are respectively connected to the flexible skirt piece 1, and the threading cavity is formed between the middle of the connecting piece 8 and the flexible skirt piece 1.

In some possible embodiments, both ends of the flexible skirt piece 1 are respectively provided with a width edge, a first adhering member is provided on one of the width edges, and an extension piece 7 is provided on the other of the width edges, a second adhering member is provided on the extension piece 7, thickness end faces of adjacent two flexible skirt pieces 1 are fitted together, and the second adhering member on the extension piece 7 is adhered to the first adhering member. The extension piece 7 may be located inside the flexible skirt piece 1, which does not affect appearance of the flexible skirt piece 1. One of the first adhering member and the second adhering member may be a loop fastener 5, and the other may be a hook fastener 6.

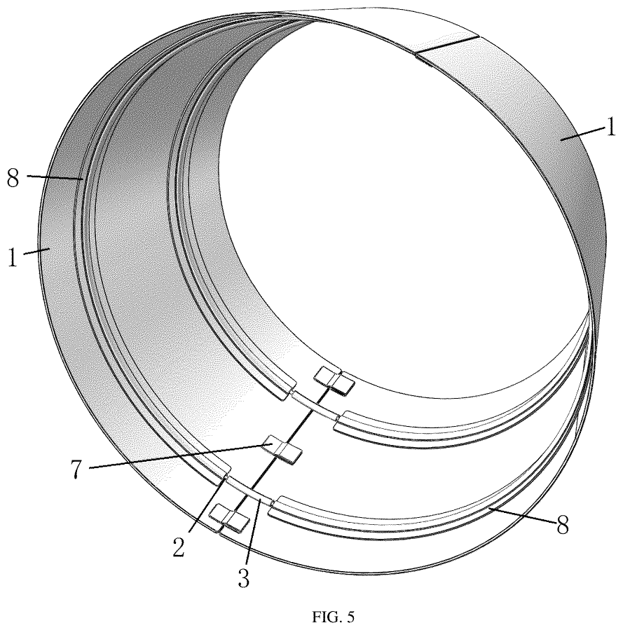

Referring to FIG. 5, a plurality of extension pieces 7 are provided on the width edge of the flexible skirt piece 1, the extension pieces 7 are sequentially spaced apart in an extension direction of the width edge, and each of the support assemblies is located between adjacent two extension pieces 7. Thus, a gap between the adjacent two flexible skirt pieces 1 is uniform and stable, avoiding the problem of uneven gaps.

The preferred embodiments of the present application disclosed above are intended only to illustrate the present application. It is not intended to elaborate all details of the preferred embodiments, nor is it intended to limit the application to only the specific embodiments described. Obviously, many modifications and variations are possible in light of the above teaching. The embodiments were chosen and described in order to best explain the principles and practical application of the present application and to thereby enable those skilled in the art to best understand and utilize the present application. The present application is to be limited only by the claims, along with their full scope and equivalents.

What is claimed is:

1. A tree skirt, comprising:
a tree skirt body, wherein the tree skirt body comprises a plurality of flexible skirt pieces, the flexible skirt pieces are sequentially arranged along a circular track, adjacent flexible skirt pieces are detachably connected, the flexible skirt pieces are enclosed to form a cavity, and the tree skirt body has an upper opening and a lower opening communicating with the cavity; and
at least two sets of support assemblies, wherein the sets of support assemblies are sequentially spaced apart along a center line of the cavity, one of the support assemblies is close to the upper opening, the other of the support assemblies is close to the lower opening, the support assemblies comprises at least two support strips and at least two connecting members, each of the support strips is respectively connected to a corresponding flexible skirt piece, and each of the connecting members is respectively located between adjacent two support strips and is respectively connected to the two support strips,
wherein the connecting member is detachably connected to at least one of the support strips.

2. The tree skirt according to claim 1, wherein the connecting members extend along an arc, the connecting members are fitted to an inner surface of the tree skirt body, and one of the two adjacent support strips is fixedly connected to the connecting member, and the other of the two adjacent support strips is detachably connected to the connecting member.

3. The tree skirt according to claim 2, wherein the connecting members are respectively provided with a slot, one of the adjacent two support strips is fixedly connected to the connecting member, and the other of the adjacent two support strips is detachably connected to the slot.

4. The tree skirt according to claim 3, wherein one of the adjacent two support strips is fixedly connected to the connecting member by any of welding, adhering, insertion and snap-in.

5. The tree skirt according to claim 4, wherein the connecting member is an arc-shaped hollow tube, and the connecting member has a through slot therein; and
one of the adjacent two support strips is inserted into and in an interference fit with the slot, and the other of the adjacent two support strips is detachably connected to the slot.

6. The tree skirt according to claim 5, wherein an outer surface of one of the adjacent two support strips at an end thereof is provided with a concavo-convex pattern portion, so that the concavo-convex pattern portion is in a close fit with an inner wall of the slot in a state of being inserted into the slot.

7. The tree skirt according to claim 5, wherein the slot of the connecting member has a first slot segment and a second slot segment;
a length of the first slot segment is shorter than that of the second slot segment; and
one of the adjacent two support strips is in an interference fit with the first slot segment, and the other of the adjacent two support strips is detachably connected to the second slot segment.

8. The tree skirt according to claim 1, wherein a connecting piece is connected to an inner surface of the flexible skirt piece, and a threading cavity is formed between the connecting piece and the flexible skirt piece; and
the support strip is arranged through the threading cavity.

9. The tree skirt according to claim 1, wherein both ends of the flexible skirt piece are respectively provided with a width edge;
a first adhering member is provided on one of the width edges, an extension piece is provided on the other of the width edges, and a second adhering member is provided on the extension piece; and
thickness end faces of the adjacent two flexible skirt piece are fitted together, and the second adhering member on the extension piece is adhered to the first adhering member.

10. The tree skirt according to claim 9, wherein a plurality of extension pieces are provided on the width edge of the flexible skirt piece, and the extension pieces are sequentially spaced apart in an extension direction of the width edge; and
each of the support assemblies is located between adjacent two extension pieces.
